(19) United States
(12) Patent Application Publication
(10) Pub. No.: US 2009/0264668 A1
(43) Pub. Date: Oct. 22, 2009

(54) METHOD FOR PRODUCTION OF FINEPARTICLE AND METHOD FOR PRODUCTION OF INDIUM ORGANOCARBOXYLATE

(76) Inventor: Shuzo Tokumitsu, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/375,456

(22) PCT Filed: Jul. 30, 2007
(86) PCT No.: PCT/JP2007/065309

§ 371 Date: Feb. 11, 2009

(30) Foreign Application Priority Data
Jul. 31, 2006 (JP) 2006-207960

(51) Int. Cl. C07F 5/00; C01B 25/00

(52) U.S. Cl. 556/1; 423/299

(57) ABSTRACT

A method for producing fine particles having in their molecules at least one element “X” selected from P, As and Sb and at least one element “Y” selected from Ga, In, Zn, Cd, Si, Ge and Sn, the method comprising the steps of (a) mixing a raw material for said element X and a raw material for said element Y in a solvent to prepare a raw material mixture solution, and (b) increasing the temperature of said raw material mixture solution to a predetermined reaction temperature on the basis of a predetermined interrelationship between a reaction temperature and an average particle diameter of fine particles to be generated, and a method for producing indium organocarboxylate, which comprises reacting an indium alkoxide and an organic carboxylic anhydride.

### TECHNICAL FIELD

This invention relates to a method for producing fine particles and a method for producing indium organocarboxylate. More specifically, this invention relates to a method for producing fine particles such as InP fine particles that are expected to be a luminescence center material, the method permitting controlling a particle size by a simple means and being applicable to mass-production without the necessity of using a special apparatus (micro flow reactor, etc.) or controlling complicated conditions, and a method for easily and industrially advantageously producing indium organocarboxylate useful as an In source in the production of InP fine particles, etc.

### BACKGROUND ART

In recent years, semiconductor fine crystals (fine particles) attract attention and studies thereof are actively under way. Semiconductor fine crystals have a feature that even the same material permits the controlling of emission wavelength on the basis of quantum confinement effects by controlling the particle size thereof, and they are expected to be luminescence center materials.

Of these, CdSe crystallite is easily produced and the particle size of CdSe is also relatively easily controllable, so that it has high utility and that studies thereof have been advanced. However, its disadvantage is that it has toxicity derived from Cd.

On the other hand, InP crystallite does not have the toxicity problem that Cd has, and it hence attracts attention as a luminescence center.

Various methods have been so far known as an InP synthesis method. For example, as a wet process, there has been reported (1) a method in which a mixture of ((CH₂)₇CH₃)₃ and OP(CH₂)₇CH₃)₃ is used as a solvent, InCl(COO)₂ is used as an In material, P(Si(CH₃)₃)₃ (to be sometimes described as P(TMS)₃ hereinafter) is used as a P material and these materials are reacted at 260 to 300° C. for 3 to 6 days to carry out synthesis (for example, see “J. Phys. Chem.”, Vol. 98, page 4,966 (1994)), (2) a method in which In(OR)₃ is used as an In material, excess P(TMS)₃ is used as a P material and these materials are reacted in a boiling pyridine solvent to directly synthesis toluene-soluble amorphous InP (more specifically, InP[P(TMS)₃]ₓ) (for example, see “Polyhedron”, Vol. 13, page 1,131 (1994)), or the like.

However, the above method (1) takes a long period of time for the synthesis and has poor productivity, and it cannot be said that the method is satisfactory for industrially practicing the same. Further, in the method (2), generated InP is amorphous and cannot be used as a light-emitting material for a luminescence center, or the like.

Further, InP particles obtained by any conventional method have a disadvantage that they have poor dispersibility in a solvent and are liable to precipitate during a reaction.

Further, there has been reported a method in which an octadecene (ODE) solution of a long-chain fatty acid indium salt is pre-heated up to a predetermined temperature and an ODE solution of tris(trimethylsilyl)phosphine (P(TMS)₃) is injected therein for the shortest period of time possible, thereby to synthesize InP nanocrystal (for example, see “Nano Lett.”, Vol. 2, page 1,027 (2002) and “Chem. Mater.”, Vol. 17, page 3,754 (2005))

In the above method, the size of fine particles to be generated is controlled by a reaction time period. That is, it is a method in which a crystalline nucleus is uniformly generated in a system by charging P(TMS)₃ into the reactor as promptly as possible, a subsequent particle growing reaction starts at the same point of time with regard to all of particles and the particles having the distribution of uniform sizes are synthesized by rapidly terminating the reaction at a certain growth stage of the particles. In this method, therefore, it is intended to change particles in size on the basis of a reaction time period, but it is very poorly capable of controlling the particle size.

Further, there has been disclosed a method in which a solution containing indium acetate, a ligand such as myristic acid, palmitic acid or the like and a solvent capable of no ligand performance such as octadecene or the like is heated up to a high temperature of approximately 300° C., an octadecene solution containing P(TMS)₃ is injected therein once or many times, and the mixture is allowed to react at approximately 250 to 270° C. to generate an InP nanocrystal (for example, see PCT Japanese Translation Version No. 2005-521755).

In this reaction, not only acetic acid formed as a byproduct may remain in the system, but also P(TMS)₃ may be decomposed due to a presence of active proton in the system to generate toxic phosphine.

With regard to the production of InP particles by a wet process, various methods are known as described above. However, nothing has been referred to with regard to the relationship between the reaction temperature and the particle size of InP particles to be generated. Further, there has been no case in which the size of InP particles to be generated us controlled on the basis of the reaction temperature.

On the other hand, with regard to indium organocarboxylate used as one material for the synthesis of InP fine particles, for example, there are known (1) a method in which indium acetate is heated in an octadecene solution containing an equivalent weight of a fatty acid to evaporate acetic acid and indium organocarboxylate is thereby obtained (for example, see “Nano Lett.”, Vol. 2, page 1,027 (2002)), and (2) a method in which indium organocarboxylate is obtained by a reaction between tris(cyclopentadienyl) indium and a fatty acid (for example, see “Chem. Mater.”, Vol. 17, page 3,754 (2005)).

However, the disadvantage with the above-described method (1) is that unreacted fatty acid can remain in the system and that acetic acid formed as a byproduct can remain in the system. Since these supply the system with active proton, they are causes that lead to decomposition of P(TMS)₃ to generate phosphine that is a toxic gas.

In the above method (2), tris(cyclopentadienyl) indium is extremely highly reactive and thermally instable and has a risk of being ignited when brought into contact with oxygen or water. Moreover, its storage and handling require strict attentions and suitable facilities. As far as we have searched, there is no “reagent” company dealing with such a reagent, and it is required to synthesize a raw material. However, the synthesis is very difficult for the above reasons. Further, fatty acid that remains causes detrimental effects similar to those in the former method.

### DISCLOSURE OF THE INVENTION

Under the circumstances, it is an object of this invention to provide a method for producing fine particles such as InP fine particles that are expected to be a luminescence center material, the method permitting controlling a particle size by a simple means and being applicable to mass-production without the necessity of using a special apparatus (micro flow reactor, etc.) or controlling complicated conditions, and a method for easily and industrially advantageously producing indium organocarboxylate useful as an In source in the production of InP fine particles, etc.

For achieving the above object, the present inventor has made diligent studies. As a result, when particles having in molecules thereof at least one element X selected from P, As and Sb and at least one element selected from Ga, in, Zn, Cd, Si, Ge and Sn are produced, it has been found that the size of fine particles to be generated can be controlled on the basis of a reaction temperature for a reaction of a raw material for the above element X with a raw material for the above element Y in a solvent, and with focusing on this recognition, it has been found that fine particles having a desired average particle diameter can be obtained by simple means of increasing the temperature of a mixture solution containing a raw material for the above element X and a raw material for the above element Y to a predetermined temperature on the basis of a predetermined interrelationship between a reaction temperature and an average particle diameter of fine particles to be generated.

Further, it has been found that indium organocarboxylate to be used as a raw material for the above element Y can be easily and industrially advantageously produced by reacting indium alkoxide with organic carboxylic anhydride.

This invention has been completed on the basis of these findings.

That is, this invention provides

(1) a method for producing fine particles having in their molecules at least one element selected from P, As and Sb and at least one element selected from Ga, In, Zn, Cd, Si, Ge and Sn,

the method comprising the steps of

(a) mixing a raw material for said element X and a raw material for said element Y in a solvent to prepare a raw material mixture solution, and

(b) increasing the temperature of said raw material mixture solution to a predetermined reaction temperature on the basis of a predetermined interrelationship between a reaction temperature and an average particle diameter of fine particles to be generated,

(2) a method as recited in the above (1), wherein the raw material for the element X contains a compound of the general formula (I),

Xₙ(SIR¹₃)ₘ (I)

and/or a compound of the general formula (II),

XHₚ(Si²₃)_{q} (II)

wherein each of n, m, p and q is an integer of 1 or more, and each of R¹ and R² is an alkyl group, an aryl group or an aralkyl group,

(3) a method as recited in the above (1) or (2), wherein the raw material for the element Y contains an organic oxoacid salt or an alkoxide,

(4) a method as recited in any one of the above (1) to (3), wherein the reaction temperature is 80 to 350° C.,

(5) a method as recited in the above (1) to (4), wherein the fine particles are InP fine particles,

(6) a method as recited in the above (5), wherein an in raw material for producing the InP fine particles is an indium organocarboxylate prepared from an indium alkoxide and an organic carboxylic anhydride,

(7) a method as recited in any one of the above (1) to (6), wherein the fine particles have an average particle diameter of 1 to 10 nm,

(8) a method as recited in any one of the above (1) to (7), wherein each of the step (a) and the step (b) is practiced by a batch method,

(9) a method for producing indium organocarboxylate, which comprises reacting an indium alkoxide and an organic carboxylic anhydride, and

(10) a method as recited in the above (9), wherein the organic carboxylic anhydride is an anhydride of a long-chain fatty acid having 4 to 30 carbon atoms.

According to this invention, fine particles such as InP fine particles that are expected to be a luminescence center material can be produced by simple means without the necessity of using a special apparatus (micro flow reactor, etc.) or controlling complicated conditions, the method permitting the control of the particle size and also being applicable to mass-production.

Further, indium organocarboxylate useful as an In source in the production of InP fine particles, etc., can be easily and industrially advantageously produced.

### BRIEF DESCRIPTION OF DRAWINGS

FIG. 1 is a graph showing a relationship between a reaction temperature and an average particle diameter of InP particles in Example 2.

FIG. 2 shows visible ultraviolet light absorption spectra of InP fine particles obtained by varying a reaction temperature between 160 and 220° C. in Example 2.

FIG. 3 shows XRD patterns of InP fine particles obtained by varying a reaction temperature between 160 and 220° C. in Example 2.

FIG. 4 shows visible ultraviolet light absorption spectra of InP fine particles obtained by employing a constant reaction temperature of 220° C. and varying a reaction time period between 5 and 60 minutes in Example 2.

FIG. 5 is a photoluminescence spectrum of ZnSe-coated InP fine particles obtained in Example 2.

FIG. 6 is a photoluminescence spectrum of ZnS-coated InP fine particles obtained in Example 3.

FIG. 7 is a photoluminescence spectrum of a dispersion of ZnS-coated InP fine particles in water obtained in Example 3.

### PREFERRED EMBODIMENTS OF THE INVENTION

The method for producing fine particles, provided by this invention, is a method for producing fine particles having in their molecules at least one element “X” selected from P, As and Sb and at least one element “Y” selected from Ga, In, Zn, Cd, Si, Ge and Sn, and the above method has the steps of (a) mixing a raw material for said element X and a raw material for said element Y in a solvent to prepare a raw material mixture solution, and

(b) increasing the temperature of said raw material mixture solution to a predetermined reaction temperature on the basis of a predetermined interrelationship between a reaction temperature and an average particle diameter of fine particles to be generated.

As a raw material for the above at least one element X selected from P, As and Sb, for example, there can be used a raw material containing a compound of the general formula (I),

Xₙ(SIR¹₃)ₘ (I)

and/or a compound of the general formula (II),

XHₚ(SiR²₃)_{q} (II)

wherein each of n, m, p and q is an integer of 1 or more, and each of R¹ and R² is an alkyl group, an aryl group or an aralkyl group.

In the above general formulae (I) and (II), the alkyl group represented by R¹ and R² includes a linear or branched alkyl group having 1 to 5 carbon atoms. Examples of this alkyl group include methyl, ethyl, n-propyl, isopropyl, n-butyl, isobutyl, etc.

The aryl group represented by R¹ and R² includes an aryl group having 6 to 10 carbon atoms, and examples thereof include phenyl, tolyl, xylyl, naphthyl, etc. Further, the aralkyl group includes an aralkyl group having 7 to 10 carbon atoms, and examples thereof include benzyl, phenethyl, phenylpropyl, methylbenzyl, methylphenethyl, etc.

Each of three R¹s may be the same as, or different from, every other one, and each of three R²s may be the same as, or different from, every other one.

The compound of the general formula (I), Xₙ(SiR¹₃)ₘ, is preferably a compound of the general formula (I) in which X is P. Examples of the compound represented by Pₙ(SiR¹₃)ₘ include tris(trimethylsilyl)phosphine, tris(triethylsilyl)phosphine, tris(tri-n-propylsilyl)phosphine, tris(triisopropylsilyl)-phosphine, tris(dimethylphenylsilyl)phosphine, tris(dimethylbenzylsilyl)phosphine, etc.

Further, the compound of the general formula (II), XHₚ(SiR¹₃)_{q}, is preferably a compound of the general formula (II) in which X is P, and the compound represented by PHₚ(SiR²₃)_{q} includes, for example, bis(trimethylsilyl)phosphine PH(Si(CH₃)₃)₂, etc.

One of these raw materials for the element X may be used singly, or two or more raw materials of them may be used in combination. Of these, tris(trimethylsilyl)-phosphine is preferred in view of reactivity.

As a raw material for the at least one element Y selected from Ga, In, Zn, Cd, Si, Ge and Sn, there can be used a raw material containing an organic oxoacid salt or an alkoxide.

The above organic oxoacid salt can be selected from organic carboxylate [A-C(═O)O—], organic phosphate [A-O—P(═O)(—O)O—], organic phosphonate [A-P(═O)(—O)O—], organic sulfonate [A-S(═O)(═O)O—], etc.

In the reaction between the organic oxoacid salt and the above Xₙ(SiR¹₃)ₘ or XHₚ(SiR²₃)_{q}, a reaction product is eliminated in the form of A-C(═O)O—SiR₃ (R═R¹ or R²) when the raw material for the element Y is an organic carboxylate, it is eliminated in the form of A-O—P—(═O)(—O)O—SiR₃ when the raw material for the element Y is an organic phosphate, it is eliminated as A-P(═O)(—O)O—SiR₃ when the raw material for the element Y is an organic phosphonate, it is eliminated as A-S(—O) (═O)O—SiR₃ when the raw material for the element Y is an organic sulfonate, and they are all eliminated through a six-membered ring. Further, when the raw material for the element Y is an alkoxide [AO—], it is eliminated as A-O—SiR₃ through a four-membered ring.

The above “A” represents an alkyl group or an alkenyl group.

In this invention, one of the above raw materials for the element Y may be used singly, or two or more of them may be used in combination. Of these, the organic carboxylate is preferred from the viewpoint of dispersibility of fine particles formed in a non-polar solvent or easiness in the synthesis of a raw material. As an organic carboxylic acid for constituting the above organic carboxylate, an organic monocarboxylic acid is preferred, and a long-chain fatty acid having 4 to 30 carbon atoms is more preferred. Examples of the long-chain fatty acid having 4 to 30 carbon atoms include decanoic acid, lauric acid, myristic acid, palmitic acid, stearic acid, itaconic acid, behenic acid, oleic acid, etc.

In this invention, any reaction solvent can be used as long as it does not react with any one of the raw material for the element X and the raw material for the element Y under reaction conditions but can dissolve a fatty acid in salt that is a raw material.

In this invention, the step (a) is started first, in which the raw above material for the element X and the above raw material for the element Y are mixed in the above solvent, to prepare raw material mixture solution. The temperature at which the raw materials are mixed in the solvent is preferably 10 to 40° C. (room temperature).

With regard to the amount ratio of the raw material for the element Y and the raw material for the element X, from the viewpoint of dispersibility of fine particles obtained in a solvent, preferably, the raw material for the element Y and the raw material for the element X are used such that the amount of Y atoms is stoichiometrically in excess of the amount of X atoms. More preferably, they are used such that the proportions of Y atoms and X atoms by molar ratio are 1:0.1 to 1:1, and particularly preferably, such that they are 1:0.5 to 1:0.8.

From the viewpoint of reactivity of the raw material for the element X and the raw material for the element Y and reactivity and dispersibility of fine particles formed, further, the concentration thereof in the solvent as a concentration of Y is generally approximately 0.005 to 0.5 mol/L, preferably 0.01 to 0.1 mol/L.

Then, in the step (b), the raw material mixture solution prepared in the above step (a) is temperature-increased to a predetermined reaction temperature on the basis of a predetermined interrelationship between a reaction temperature and the average particle diameter of fine particles to be generated, to carry out a reaction.

The present inventor has made this invention by finding that the particle size of fine particles to be generated can be controlled by a reaction temperature in the reaction of the above raw material for the element X and the raw material for the element Y in a solvent.

The control of particle size of InP nanocrystal in this invention will be discussed. In this invention, for example, fatty acid indium and tris(trimethylsilyl)-phosphine [P(TMS)₃] are mixed in a trioctylphosphine solvent at room temperature in advance, and the mixture is heated to a predetermined temperature whereby the particle size of InP nanocrystal to be formed is controlled on the basis of a reaction temperature alone. The reason why the particle size of InP nanocrystal can be controlled on the basis of a heating temperature alone is considered to be that the growth process of the InP nanocrystal is controlled by Ostwald growth (growth of particles by fusion of particles). That is, it is considered that fatty acid indium and P(TMS)₃ react with each other even at room temperature to form fine clusters having InP bonds. As the reaction solution is heated, fatty acid silyl ester is eliminated from the clusters at ˜80° C. by beta elimination, whereby InP fine crystal having a unit cell of a zinc blend structure is formed. It is considered that, due to a size effect, this InP fine crystal has, depending upon temperatures, a lower limit in the size of particles that can stably maintain the structure. Since the lower-limit size increases with an increase in temperature, a smaller fine crystal is in a more instable state at a lower temperature and associatively grows by collision/fusion up to the size of particles that can stably maintain a structure. It is considered that, in the associative growth, the fusion of particles having the lower-limit size or smaller takes place prior to any other due to the instability thereof. When the temperature of the reaction solution increases, therefore, particles that are stable at a lower temperature start associative growth if they have a size smaller than the lower-limit particle size, and stop growing when they reach the size of particles that can stably maintain a structure. It is considered that this process is repeated during the temperature-increasing of the reaction solution. When the temperature of the reaction solution is stopped from increasing and constant at a certain temperature, therefore, only particles having a size slightly larger than the lower-limit size are present in the solution. It is therefore considered that this invention enables the control of the particle size of InP nanocrystal on the basis of only a reaction temperature without relaying on a temperature elevation speed or a reaction time period.

It is thought that this invention is based on the growth process different from the “control of particle size based on a reaction time period” that is conventionally employed. The growth process of this invention is suitable for fine particles having high covalent bond capability, such as group 15-group 13 compounds, 12-14-15 group charcopyrite type compounds (e.g., ZnGeP₂), etc.

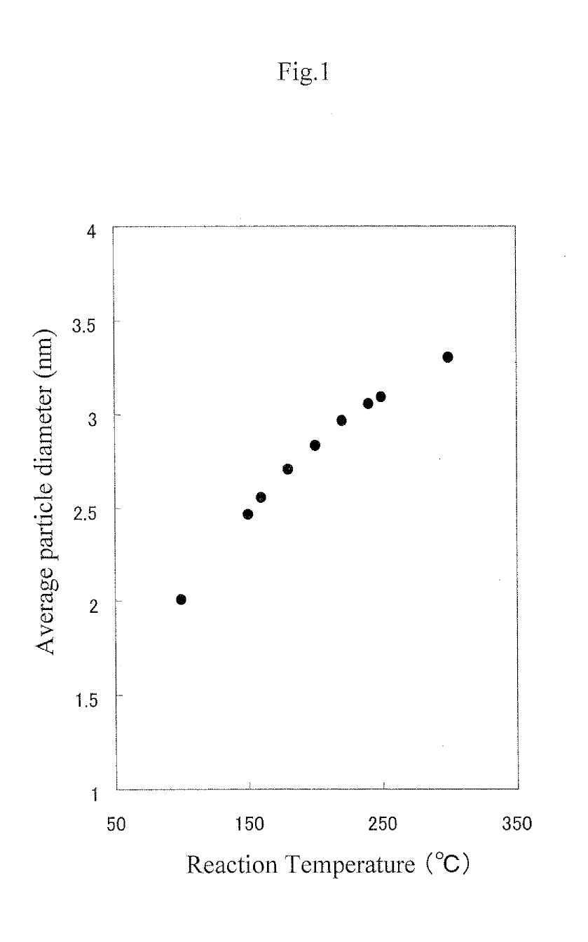

FIG. 1 is a graph showing a relationship between a reaction temperature and an average particle diameter of formed InP fine particles in a reaction between indium myristate and P(TMS)₃ in trioctylphosphine (see Example 2).

It is seen from FIG. 1 that the reaction temperature and the average particle diameter of InP fine particles have an interrelationship and that with an increase in the reaction temperature, the average particle diameter of the InP fine particles increases. Therefore, an interrelationship between a reaction temperature and the average particle diameter of fine particles formed is determined beforehand by the use of raw materials and a solvent that will be used in a reaction for obtaining fine particles to be produced, and the reaction is carried out by increasing the reaction temperature up to a predetermined temperature on the basis of the interrelationship, whereby fine particles having a desired average particle diameter can be produced.

That is, according to the method of this invention, the particle size of fine particles to be generated can be easily controlled on the basis of a reaction temperature. Further, it is known that the photoluminescence wavelength changes with particle size (with a decrease in particle size, the photoluminescence wavelength shifts toward the short wavelength side), and the photoluminescence wavelength can be hence controlled on the basis of a reaction temperature.

In the invention, the reaction temperature is generally approximately 80 to 350° C., preferably 120 to 300° C., from the viewpoint of a reaction speed, the particle size and dispersibility of fine particles generated and the boiling point and thermal stability of a solvent used.

The reaction pressure is not specially limited, and the reaction can be carried out under atmospheric pressure or elevated pressure. Generally, the reaction is carried out under atmospheric pressure when the boiling point of a solvent used is the reaction temperature or higher. It is carried out under a spontaneous pressure when the above boiling point is less than the reaction temperature.

The reaction time period changes depending upon the reaction temperature, the kinds of a raw material for the element X and a raw material of the element Y and the kind of a solvent and cannot be uniformly determined. However, it is generally approximately 1 to 600 minutes, preferably 5 to 300 minutes, more preferably 5 to 200 minutes.

The method of this invention has a feature that the particles size of fine particles to be obtained can be remarkably easily controlled since the average particle diameter of the fine particles to be obtained does not depend upon any one of a temperature elevation rate when the reaction is started, a heating time period during the reaction (reaction time period) and a cooling speed after the reaction is completed.

In this invention, from the viewpoint of a particle size distribution and easiness in operation, each of the above steps (a) and (b) is preferably carried out by a batch method.

In this manner, fine particles having an average particle diameter of approximately 1 to 10 nm can be easily produced by simple means.

Desirably, the method of this invention is applied to the production of fine particles, in particular, of InP fine particles. In this case, as an in raw material for producing InP fine particles, indium organocarboxylate prepared from an indium alkoxide and an organic carboxylic anhydride is preferred, and indium organocarboxylate prepared from indium trialkoxide and organic monocarboxylic anhydride is particularly preferred.

The above indium trialkoxide can be selected, for example, from Indium trimethoxide, Indium triethoxide, indium tri-n-propoxide, indium triisopropoxide, indium tri-n-butoxide, indium triisobutoxide, indium tri-sec-butoxlde, etc.

The organic monocarboxylic anhydride is preferably an anhydride of a long-chain fatty acid having 4 to 30 carbon atoms. Examples of the anhydride of a long-chain fatty acid include anhydrides of fatty acids such as decanoic acid, Lauric acid, myristic acid, palmitic acid, stearic acid, itaconic acid, behenic acid, oleic acid, etc.

The reaction of the indium trialkoxide and organic monocarboxylic anhydride is preferably carried out in a solvent that dissolves them and that does not react with the above compounds in a reaction temperature. In the fatty acid indium obtained by the above method, fatty acid alkyl ester formed as a byproduct can be removed, for example, by washing with ethanol, etc., and purified fatty acid indium can be obtained.

As a conventional method for producing a fatty acid indium, for example, there is known (1) a method for obtaining fatty acid indium in which indium acetate is heated in an octadecene solution containing an equivalent weight of a fatty acid to evaporate acetic acid or (2) a method in which tris(cyclopentadienyl) indium and a fatty acid are allowed to react to obtain fatty acid indium. In the above method (1), however, the disadvantage thereof is the possibility of an unreacted fatty acid remaining in the system and the possibility of acetic acid formed as a byproduct remaining in the system. Since these provide the system with active proton, these are causes that lead to decomposition of P(TMS)₃, etc., in the reaction of fatty acid indium with P(TMS)₃, etc., by generating a phosphine that is a toxic gas.

In the above method (2), further, tris(cyclopentadienyl) indium is extremely highly active and thermally instable, and has a risk of being ignited when brought into contact with oxygen or water. Moreover, its storage and handling require strict attention and suitable facilities, and it is difficult to obtain the same. Further, fatty acid that remains causes such detrimental effects as those in the above method (1).

In contrast, in a method for obtaining fatty acid indium by a reaction between an indium trialkoxide and an organic monocarboxylic anhydride like the present invention, no compound having active proton is used as a raw material, so that no decomposition of P(TMS)₃, etc., by active proton takes place, and moreover, fatty acid alkyl ester generated as a byproduct has no influence on the formation of InP, and can be easily removed by washing with ethanol, etc., and compounds as raw materials are easily available.

According to this invention, there is also provided a method for producing indium organocarboxylate which comprises reacting an indium trialkoxide with an organic monocarboxylic anhydride. Details of this production method are as already described.

In the production of an InP crystal, a mixture solution containing fatty acid indium obtained as described above, Pₙ(SiR¹₃), and/or PHₚ(SiR²₃)_{q} (m, m, p, q, R¹ and R² are as defined already) and, preferably, a solvent is temperature-increased up to a predetermined temperature on the basis of a predetermined interrelationship between a reaction temperature and the average particle diameter of InP fine particles generated, whereby InP fine particles having a desired particle diameter can be produced. The reaction temperature is preferably selected in the range of 80 to 350° C. InP fine particles obtained preferably have an average particle diameter of 1 to 10 nm. In this case, the InP fine particles have a photoluminescence wavelength of approximately 450 to 800 nm.

The thus-formed InP fine particles exhibit high dispersibility in a nonpolar solvent such as toluene or the like, since molecules having a long-chain alkyl group or long-chain alkenyl group are coordinated on their surfaces.

When molecules that are coordinated on the surfaces of the above InP fine particles are replaced with molecules having high affinity to a polar solvent, there can be prepared InP fine particles that exhibit high dispersibility in a polar solvent. Examples of the molecules having high affinity to a polar solvent include hydroxyacetic acid, mercaptoacetic acid, mercaptosuccinic acid, 10-carboxy-1-decanethiol, etc.

In this invention, shells of ZnSe, ZnS, or the like can be formed on the surfaces of the above-produced InP fine particles by a conventionally known method without separating the InP fine particles from the reaction solution. When the above shells are formed on the surfaces of the InP fine particles, there can be obtained the effect of confinement of exciton inside the InP fine particles, so that the photoluminescence intensity derived from the exciton can be increased.

According to the method for producing fine particles, provided by this invention, fine particles such as InP fine particles that are expected to be a luminescence center material can be produced without the necessity of using a special apparatus (micro flow reactor, etc.) or controlling complicated conditions but by simple means in a manner that the method enables the controlling of the particle size thereof (controlling of photoluminescence wavelength) and that the fine particles can be mass-produced.

### EXAMPLES

This invention will be explained more in detail with reference to Examples hereinafter, while this invention shall not be limited by these Examples.

### Example 1

### Preparation of Indium Myristate Solution

In a glove box filled with nitrogen, 379 mg of indium triisopropoxide (supplied by Kojundo Chemical Laboratory Co., Ltd.) was dissolved in 50 g of trioctyl phosphine purified by distillation under reduced pressure (TOP: supplied by Tokyo Chemical Industry Co., Ltd.), to prepare a 0.05 mol/L solution.

Then, 3.60 g of myristic anhydride (supplied by Tokyo Chemical Industry Co., Ltd.) was added thereto, and the mixture was heated at 60° C. for 10 minutes to generate indium myristate, whereby an indium myristate 0.05 mol/L TOP solution was prepared.

### Example 2

### Synthesis of InP Nanocrystal by the Use of Fatty Acid Indium

(1) Synthesis of InP Fine Particles

In a glove box filled with nitrogen, 1.2 g (1.44 mL) of a 0.05 mol/L TOP solution of tris(trimethylsilyl)phosphine [P(TMS)₃] (supplied by Acros Organics) prepared in advance was added to 1.6 g (1.83 mL) of the indium myristate solution prepared in Example 1. This reaction solution was heated in an oil bath for 10 minutes to synthesize InP fine particles. The heating temperature was selected between 100° C. and 300° C. The average particle diameter of InP fine particles generated could be controlled on the basis of the heating temperature. Then, the reaction solution was spontaneously cooled to room temperature to give a dispersion of InP fine particles in the TOP solvent. FIG. 1 shows a relationship between the reaction temperature and the average particle diameter of the InP fine particles. It is seen from FIG. 1 that there is an interrelationship between the reaction temperature and the average particle diameter of the InP fine particles generated and that as the reaction temperature increases from 100° C. to 300° C., the average particle diameter of the InP fine particles grows from 2 nm to 3.5 nm.

Table 1 shows the relationship between the reaction time period and the average particle diameter of InP fine particles when the reaction temperature was constantly set at 220° C. but the reaction time period was varied from 5 to 60 minutes.

TABLE 1

Reaction (heating)
time period (minute)

| | 5 | 10 | 30 | 50 |
|---|---|---|---|---|
| Average | 2.87 | 2.83 | 2.85 | 2.84 |
| particle | | | | |
| diameter (nm) | | | | |

It is seen from Table 1 that the average particle diameter of InP fine particles does not depend on the reaction time period (heating time period).

(2) Analysis of InP Fine Particles

About 50 mL, of ethanol (supplied by Wako-Purechemical Industry Co., Ltd.) was added to the dispersion obtained in the above (1) to generate a precipitate of InP fine particles. The generated precipitate was recovered by centrifugal separation, about 1 mL of toluene (supplied by Wako-Purechemical Industry Co., Ltd.) was added thereto to prepare a toluene dispersion of InP fine particles. Further, the procedures of ethanol addition—centrifugal separation—dispersing in toluene were repeated several times to remove free TOP remaining in the dispersion. Classification based on particle size was not carried out.

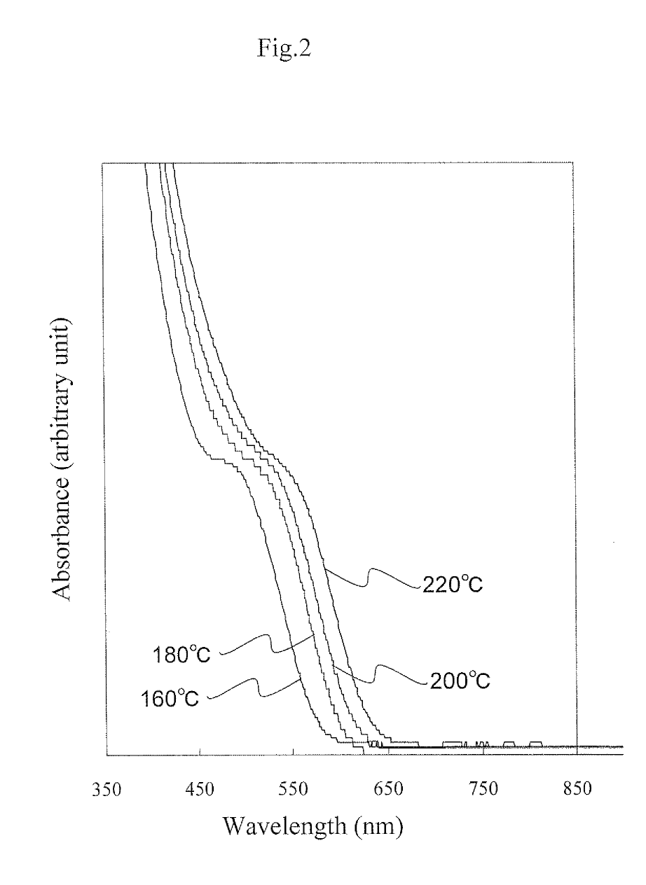

FIG. 2 shows visible ultraviolet light absorbance spectra measured with regard to diluted toluene dispersions of InP fine particles obtained at heating temperatures of 160° C. to 200° C. There were clearly observed peaks corresponding to inter-band transition of InP fine particles at 450 to 600 nm, the peaks being shifted to the short wavelength side due to the quantum confinement effect. Since the above peaks shift to the longer wavelength side with an increase in the heating temperature, it has been found that the average particle diameter of InP fine particles generated is controlled by the heating temperature and that the average particle diameter of the fine particles to be generated increases with an increase in the heating temperature.

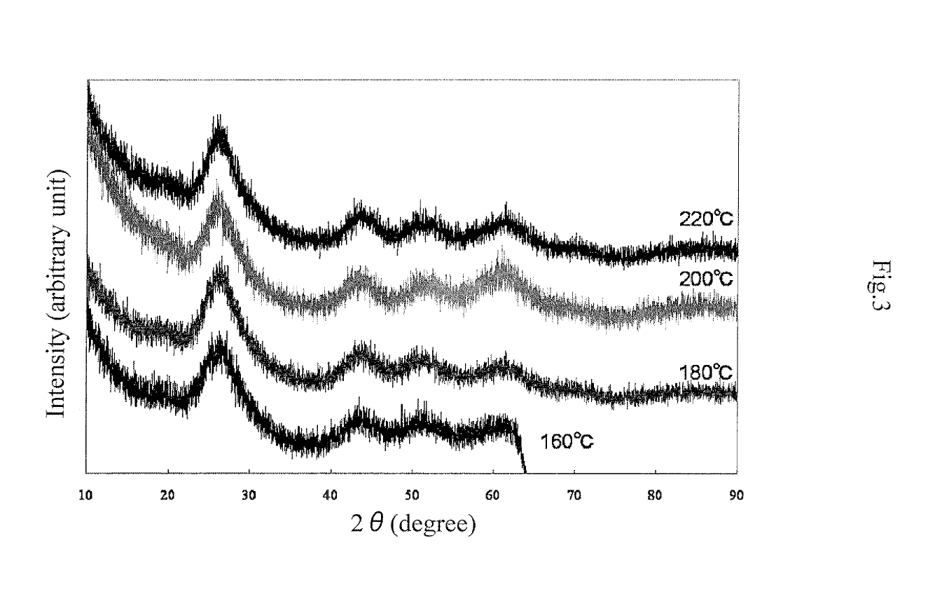

FIG. 3 shows powder X-ray diffraction (XRD) patterns of the InP fine particles obtained. It has been found that positions of diffraction peaks of them are in agreement with peak positions of bulk InP.

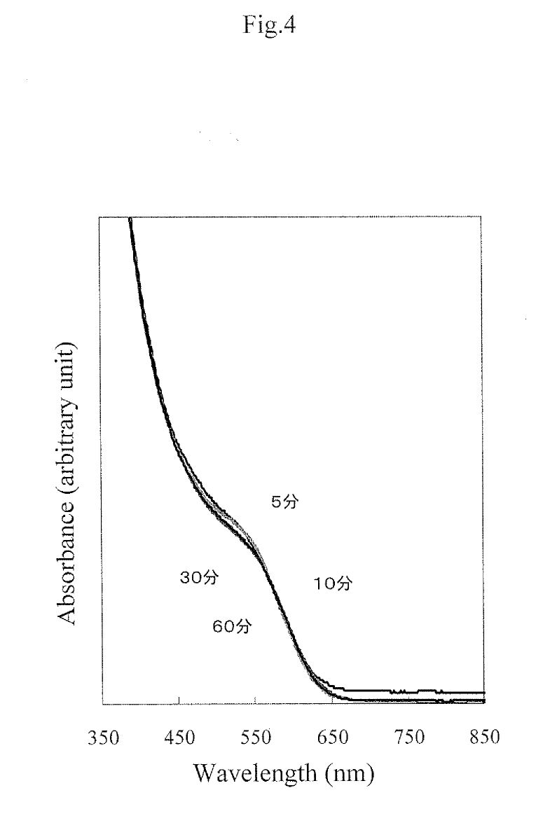

FIG. 4 shows visible ultraviolet light absorption spectra obtained by measuring diluted toluene dispersions of InP fine particles at a constant reaction temperature of 200° C. but by varying the reaction time period (heating time period) between 5 minutes and 60 minutes. It is seen from FIG. 4 that the average particle diameter of InP fine particles does not depend upon the reaction time period since the spectral curves are more or less the same when the reaction time periods are 5, 10, 30 and 60 minutes.

(3) Formation of ZnSe Shell

As described above, InP fine particles can be produced while the average particle diameter thereof is controlled on the basis of the heating temperature.

Further, since no byproduct that hampers the formation of a ZnSe shell or ZnS shell is generated, shells can be constructed without isolating generated InP fine particles from a reaction solution.

By constructing a shell formed of ZnSe, ZnS or the like on the InP fine particles obtained in the above (1), the photoluminescence from the trap level can be removed, and the exciton confinement effect in the InP fine particles by coating the InP fine particles with a material having a wider band gap than InP can be obtained, so that the photoluminescence intensity derived from the exciton can be increased.

First, precursor solutions of Zn and Se were respectively prepared by the following procedures. Reagents were used as they were without treating them unless otherwise specified.

110 Milligrams of zinc acetate dihydrate and 735 mg of oleic acid were added to 15 g of octadecene (these were all supplied by Wako-Purechemical Industry Co., Ltd.), and the mixture was heated to 180° C. while nitrogen was blown into it, whereby water and acetic acid were removed. After heated for 1 hour, the mixture was spontaneously cooled to room temperature to show the precipitation of zinc oleate. After the cooling, 5 g of TOP (supplied by Tokyo Chemical Industry Co., Ltd.) was added thereto, and the mixture was shaken until the precipitated zinc oleate was fully dissolved, to give a zinc precursor solution.

A selenium precursor solution was prepared by dissolving 494 mg of particulate selenium (diameter: approximately 2 mm) (supplied by Aldrich Corporation) in 25 g of TOP (supplied by Tokyo Chemical Industry Co., Ltd.).

Then, InP fine particles were surface-coated with ZnSe by the following procedures using the above-prepared zinc precursor solution and selenium precursor solution.

In a glove box filled with nitrogen, 1 g of the zinc precursor solution and 0.5 g of the selenium precursor solution were added to 0.2 g of the TOP dispersion of InP fine particles prepared in the above (1), and the mixture was heated at 240° C. for 15 hours. After the heating, the reaction mixture was spontaneously cooled to room temperature thereby to synthesize ZnSe-coated InP fine particles dispersed in the TOP solvent. In this case, no precipitate was observed in the dispersion.

An excess ethanol (supplied by Wako-Purechemical Industry Co., Ltd.) was added to the above-obtained dispersion to precipitate the ZnSe-coated InP fine particles. The thus-generated precipitate was recovered by centrifugal separation and dispersed in toluene. The ZnSe-coated InP fine particles exhibited high dispersibility in toluene.

When the above ZnSe-coating step is repeated using the above-obtained ZnSe-coated InP fine particles (that may be ZnSe-coated InP fine particles recovered or those obtained from the toluene dispersion by removing the solvent), the thickness of the ZnSe coating film can be increased. By increasing the thickness of the ZnSe film that coats InP, the fluorescence intensity of InP can be improved.

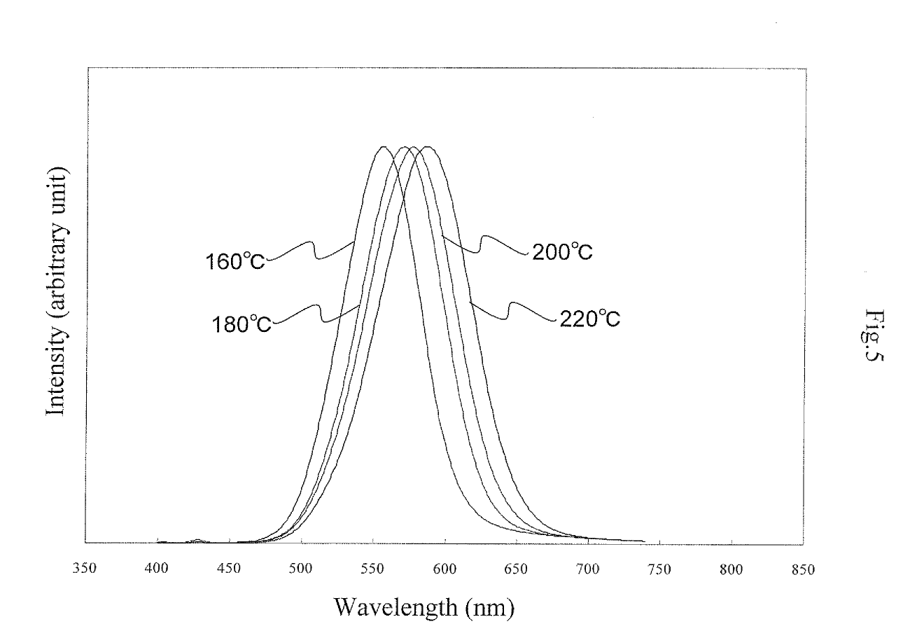

FIG. 5 shows the photoluminescence spectra of the ZnSe-coated InP line particles obtained. It has been observed that the photoluminescence peak position shifts from 550 nm to 600 nm with the temperature for synthesis of the InP fine particles. The full width at half maximum of the photoluminescence peak was approximately 70 nm. Further, the quantum yield of the photoluminescence was approximately 30%. The coated InP fine particles were improved in photoluminescence intensity as compared with those that were not coated with ZnSe (not shown). It is thought that the above is accomplished because the defect states and surface states in the vicinities of the InP fine particle surfaces disappeared since ZnSe coatings were formed on InP surfaces and because the effect of confinement of exciton in the InP fine particles could be obtained by means of ZnSe coatings having a wider band gap than the InP fine particles.

### Example 3

### Production of Water-Dispersible InP Fine Particles

Since the InP fine particles and ZnSe fine particles obtained in Example 2 had molecules having long-chain alkyl group coordinated on their surfaces, they exhibited high dispersibility in nonpolar organic solvents such as toluene, etc. By replacing these molecules coordinated on the surfaces with molecules having high affinity to water, there can be prepared InP fine particles that exhibit high dispersibility in water. The ZnSe shell is all dissolved during this coordinate-molecule replacement reaction. However, when a more chemically stable ZnS shell is introduced as an outermost layer, there can be produced InP fine particles having both high dispersibility in water and high photoluminescence efficiency.

(1) Formation of ZnS Shell

The formation of a ZnS shell can be applied both to the TOP dispersion of InP time particles produced in Example 2 and to ZnSe-coated InP fine particles. The method of introducing ZnS shells to InP fine particles will be described below. 218 Milligrams of zinc diethyldithiocarbamate (supplied by Tokyo Chemical Industry Co., Ltd.) was dissolved in 25 g of TOP to prepare a ZnS precursor solution. In a glove box filled with nitrogen, 15 g of the ZnS precursor solution was added to the TOP dispersion of InP fine particles produced in Example 1 (heating temperature 180° C.), and the mixture was heated at 200° C. for 15 hours to make ZnS-coated InP fine particles. The fine particles were separated from the reaction solvent in the same manner as in the separation of the ZnSe-coated InP fine particles.

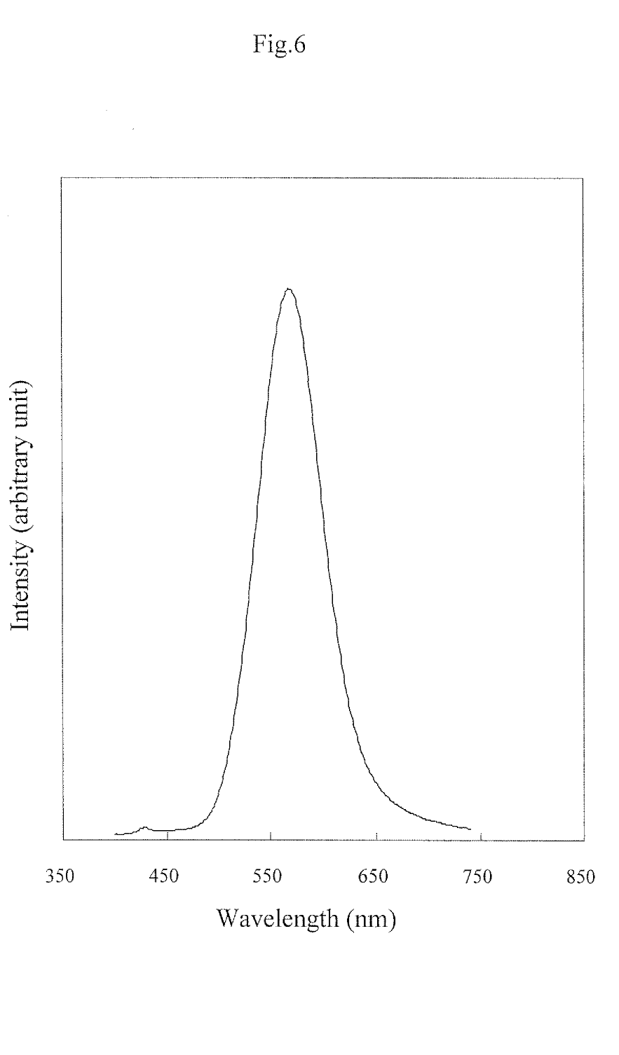

FIG. 6 shows a photoluminescence spectrum of the thus-obtained ZnS-coated InP fine particles. At a wavelength of 570 nm, a photoluminescence peak caused by exciton relaxation was observed. No photoluminescence by trap levels such as surface level was observed on the long wavelength side of the peak. This shows that the surface level of the InP fine particles was effectively extinguished by the ZnS coating and that the quantum confinement of an exciton effectively worked.

(2) Replacement of Ligand with Mercaptoacetic Acid

It is thought that myristic acid and TOP are coordinated on the outermost surface of each of the ZnS-coated InP fine particles produced in the above (i). When they are replaced with mercaptoacetic acid, the InP fine particles can be converted to InP fine particles having high dispersibility in highly polar solvents.

The ZnS-coated InP fine particles (or ZnS-coated ZnSe-coated InP fine particles) produced in the above (1) were dissolved in approximately 0.5 mL of dichloromethane (supplied by Wako-Purechemical Industry Co., Ltd.). When approximately 0.5 mL of mercaptoacetic acid (supplied by Wako-Purechemical Industry Co., Ltd.) was added thereto, a precipitate of fine particles was generated. Further, triethylamine (supplied by KANTO CHEMICAL CO., INC.) was dropwise added until the precipitate was all dissolved. This solution was stirred at room temperature for approximately 45 minutes, and then approximately 10 mL of toluene was added to generate a precipitate to generate a precipitate. The precipitate was recovered by centrifugal separation. The precipitate was washed with dichloromethane and washed with acetone (supplied by Wako-Purechemical Industry Co., Ltd.). The generated precipitate exhibited excellent dispersibility in water. Approximately 0.5 mL of deionized water was added to the precipitate to form a dispersion, and approximately 10 mL of acetone was further added to form a precipitate (when no precipitate was formed, a few drops of 2D mass % aqueous ammonia were added). The precipitate was recovered by centrifugal separation. Approximately 1 mL of deionized water was added to the precipitate to prepare a dispersion of the ZnS-coated InP fine particles in water. For removing a trace amount of mercaptoacetic acid and inorganic solts contained in this dispersion as impurities, the dispersion was subjected to purification by dialysis five times using a centrifugal concentrator (supplied by SARTORIUS K.K., molecular cutoff 50,000).

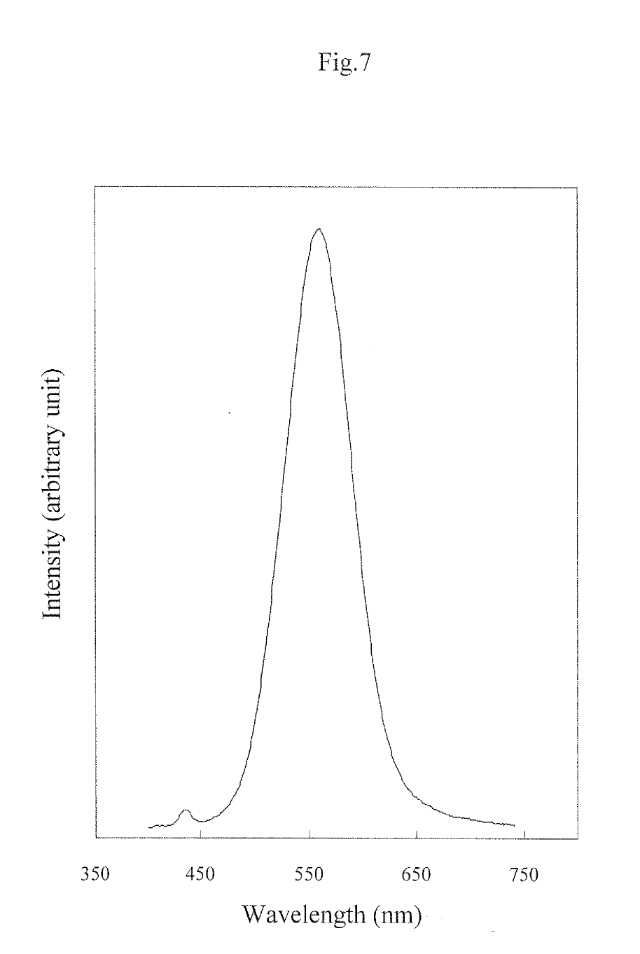

FIG. 7 shows the photoluminescence spectrum of the ZnS-coated InP fine particles that were converted to a water-dispersible product by ligand replacement. Since the form of a peak was not changed by the ligand replacement, it was found that ZnS still performed the effective confinement of the exciton of InP after the replacement reaction.

### INDUSTRIAL UTILITY

According to the method for producing fine particles, provided by this invention, fine particles such as InP fine particles that are expected to be a luminescence center can be produced in a manner that the particle size can be controlled by simple means without the necessity of using a special apparatus (micro flow reactor, etc.) or controlling complicated conditions.

Further, according to the method for producing fatty acid indium, provided by this invention, indium organocarboxylate useful as an In source in the production of InP fine particles, etc., can be easily and Industrially advantageously produced.

1. A method for producing fine particles having in their molecules at least one element “X” selected from P, As and Sb and at least one element “Y” selected from Ga, In, Zn, Cd, Si, Ge and Sn,
the method comprising the steps of
(a) mixing a raw material for said element X and a raw material for said element Y in a solvent to prepare a raw material mixture solution, and
(b) increasing the temperature of said raw material mixture solution to a predetermined reaction temperature on the basis of a predetermined interrelationship between a reaction temperature and an average particle diameter of fine particles to be generated.

2. The method of claim 1, wherein the raw material for the element X contains a compound of the general formula (I),
Xₙ(SiR¹₃)ₘ (I)
and/or a compound of the general formula (II),
XHₚ(SiR²₃)_{q} (II)
wherein each of n, m, p and q is an integer of 1 or more, and each of R¹ and R² is an alkyl group, an aryl group or an aralkyl group.

3. The method of claim 1, wherein the raw material for the element Y contains an organic oxoacid salt or an alkoxide.

4. The method of claim 1, wherein the reaction temperature is 80 to 350° C.

5. The method of claim 1, wherein the fine particles are InP fine particles.

6. The method of claim 5, wherein an In raw material for producing the InP fine particles is an indium organocarboxylate prepared from an indium alkoxide and an organic carboxylic anhydride.

7. The method of claim 1, wherein the fine particles have an average particle diameter of 1 to 10 nm.

8. The method of claim 1, wherein each of the step (a) and the step (b) is performed by a batch method.

9. A method for producing indium organocarboxylate, which comprises reacting an indium alkoxide and an organic carboxylic anhydride.

10. The method of claim 9, wherein the organic carboxylic anhydride is an anhydride of a long-chain fatty acid having 4 to 30 carbon atoms.
